(19) United States
(12) Patent Application Publication
(10) Pub. No.: US 2014/0063294 A1
(43) Pub. Date: Mar. 6, 2014

(54) IMAGE PROCESSING DEVICE, IMAGE PROCESSING METHOD, AND SOLID-STATE IMAGING DEVICE

(71) Applicant: KABUSHIKI KAISHA TOSHIBA, Tokyo (JP)

(72) Inventors: Yukiyasu Tatsuzawa, Kanagawa (JP); Kazuhiro Hiwada, Kanagawa (JP); Tatsuji Ashitani, Kanagawa (JP)

(73) Assignee: Kabushiki Kaisha Toshiba, Tokyo (JP)

(21) Appl. No.: 13/785,276

(22) Filed: Mar. 5, 2013

(30) Foreign Application Priority Data
Sep. 3, 2012 (JP) 2012-193412

(51) Int. Cl. H04N 5/265

(52) U.S. Cl. CPC H04N 5/265
USPC 348/239

(57) ABSTRACT

According to an embodiment, a high dynamic range synthesizing unit synthesizes first image signal and second image signal. A main control exposure value calculating unit calculates a main control exposure value based on a signal designated as a main control signal between the first image signal and the second image signal. A sub-control exposure value calculating unit multiplies the main control exposure value by a high dynamic range magnification and sets the multiplication result as a sub-control exposure value for a sub-control signal. The sub-control signal causes the main control signal to follow lightness adjustment.

### CROSS-REFERENCE TO RELATED APPLICATIONS

This application is based upon and claims the benefit of priority from Japanese Patent Application No. 2012-193412, filed on Sep. 3, 2012; the entire contents of all of which are incorporated herein by reference.

### FIELD

Embodiments relate generally to an image processing device, an image processing method, and a solid-state imaging device.

### BACKGROUND

High dynamic range (HDR) synthesis is known as a shooting technique for expressing a dynamic range wider than that of a normal shooting technique. As a technique for HDR synthesis, for example, there is a technique for acquiring a long-time exposure image signal and a short-time exposure image signal configured such that charge accumulation times are different from each other and generating a synthesized image. In a solid-state imaging device, when HDR synthesis images are captured and an auto exposure (AE) operation is controlled, a complicated calculation process is required for the long-time exposure image signal and the short-time exposure image signal. Therefore, there is a problem of an increase a circuit size or an increase in a processing time.

### BRIEF DESCRIPTION OF THE DRAWINGS

FIG. 1 is a block diagram illustrating an overall configuration of a solid-state imaging device according to a first embodiment;

FIG. 2 is a block diagram illustrating an overall configuration of a digital camera including the solid-state imaging device illustrated in FIG. 1;

FIG. 3 is a diagram illustrating array of pixels in a pixel array;

FIG. 4 is a diagram illustrating output characteristics of a long-time exposure pixel and a short-time exposure pixel and synthesis of image signals by an HDR synthesizing circuit;

FIG. 5 is a diagram illustrating control of an AE operation by an AE control circuit;

FIG. 6 is a diagram illustrating calculation of control amounts of ES, AG, and DG by the AE control circuit;

FIG. 7 is a block diagram illustrating the configuration of the AE control circuit;

FIG. 8 is a diagram illustrating occurrence of flicker;

FIG. 9 is a block diagram illustrating elements used for the control of the AE operation in a normal shooting mode in the AE control circuit illustrated in FIG. 7;

FIG. 10 is a block diagram illustrating the configuration of an AE control circuit included in an image processing device according to a second embodiment;

FIG. 11 is a block diagram illustrating the configuration of the AE control circuit included in an image processing device according to a third embodiment; and

FIG. 12 is a diagram illustrating calculation of control amounts of ES, AG, and DG by an AE control circuit.

### DETAILED DESCRIPTION

In general, according to an embodiment, an image processing device includes a high dynamic range synthesizing unit, an exposure value calculating unit, and a control amount converting unit. The high dynamic range synthesizing unit generates a synthesized image by synthesizing first image signal and second image signal. The first image signal is an image signal in accordance with an amount of light incident on a first pixel during a first charge accumulation period. The second image signal is an image signal in accordance with an amount of light incident on a second pixel during a second charge accumulation period. The second charge accumulation period is shorter than the first charge accumulation period. The exposure value calculating unit calculates an exposure value to which a lightness adjustment amount is reflected. The lightness adjustment amount is an adjustment amount used to adjust the lightness of the synthesized image in accordance with illuminance at the time of shooting. The control amount converting unit converts the exposure value into control amounts for an electronic shutter time, an analog gain, and a digital gain. The exposure value calculating unit includes a main control exposure value calculating unit and a sub-control exposure value calculating unit. The main control exposure value calculating unit calculates a main control exposure value based on a signal designated as a main control signal between the first image signal and second image signal. The main control exposure value is the exposure value for the main control signal. The sub-control exposure value calculating unit calculates a sub-control exposure value. The sub-control exposure value is the exposure value for a sub-control signal. The sub-control signal is one of the first image signal and second image signal other than the main control signal. The sub-control signal causes the main control signal to follow lightness adjustment. The sub-control exposure value calculating unit multiplies the main control exposure value calculated by the main control exposure value calculating unit by a high dynamic range magnification and sets the multiplication result as the sub-control exposure value. The high dynamic range magnification is set in advance as a ratio of the first charge accumulation period to the second charge accumulation period.

Hereinafter, an image processing device, an image processing method, and a solid-state imaging device according to embodiments will be described in detail with reference to the attached drawings. Further, the invention is not limited to the embodiments.

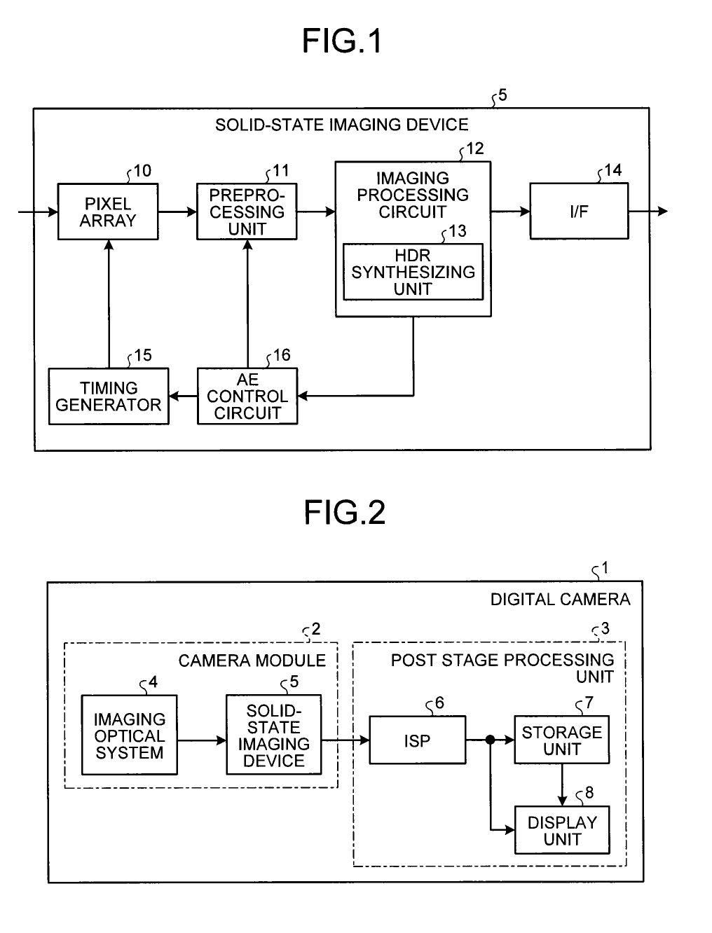

FIG. 1 is a block diagram illustrating an overall configuration of a solid-state imaging device according to a first embodiment. FIG. 2 is a block diagram illustrating an overall configuration of a digital camera including the solid-state imaging device illustrated in FIG. 1.

A digital camera 1 includes a camera module 2 and a post stage processing unit 3. The camera module 2 includes an imaging optical system 4 and a solid-state imaging device 5. The post stage processing unit 3 includes an image signal processor (ISP) 6, a storage unit 7, and a display unit 8. The camera module 2 is applied not only to the digital camera 1 but also to, for example, an electronic device such as a camera-attached portable terminal.

The imaging optical system 4 acquires light from a subject and forms a subject image. The solid-state imaging device 5 captures the subject image. The ISP 6 performs signal processing on an image signal obtained through the imaging performed by the solid-state imaging device 5. The storage unit 7 stores an image subjected to the signal processing by the ISP 6. The storage unit 7 outputs the image signal to the display unit 8 in response to a user's operation or the like. The display unit 8 displays the image according to the image signal input from the ISP 6 or the storage unit 7. The display unit 8 is, for example, a liquid crystal display.

The solid-state imaging device 5 is, for example, a complementary metal oxide semiconductor (CMOS) image sensor. The solid-state imaging device 5 may be a charge coupled device (CCD) as well as the CMOS image sensor. The solid-state imaging device 5 includes a pixel array 10, a preprocessing unit 11, an imaging processing circuit 12, an interface (I/F) 14, a timing generator 15, and an auto exposure (AE) control circuit 16.

In the pixel array 10, the light acquired by the imaging optical system 4 is converted into a signal charge by a photodiode to capture a subject image. For example, the pixel array 10 generates an analog image signal by acquiring signal values of respective color components of red (R), green (G), and blue (B) in the order corresponding to a Bayer array.

The preprocessing unit 11 performs correlated double sampling, an analog gain (AG) and a digital gain (DG) amplification, analog-to-digital conversion (AD conversion) on the image signal from the pixel array 10.

The imaging processing circuit 12 performs various kinds of signal processing on the digital image signal input from the preprocessing unit 11. The imaging processing circuit 12 includes a high dynamic range (HDR) synthesizing unit 13. The HDR synthesizing unit 13 performs HDR synthesis on the digital image signal input to the imaging processing circuit 12 to generate a synthesized image. The imaging processing circuit 12 performs not only the HDR synthesis by the HDR synthesizing unit 13 but also signal processing such as defect correction, noise reduction, shading correction, and white balance adjustment.

The I/F 14 outputs the image signal subjected to the signal processing by the imaging processing circuit 12. The I/F 14 performs a process of transmitting the image signal to an external device, for example, appropriately performs conversion from serial data to a parallel output or conversion from an parallel input to serial data.

The AE control circuit 16 controls the AE operation of the digital camera 1 according to lightness at the time of shooting. The AE control circuit 16 transmits data of the AG and the DG to the preprocessing unit 11. The AE control circuit 16 transmits data of an electronic shutter time (ES) to the timing generator 15. The imaging processing circuit 12 and the AE control circuit 16 function as an image processing device. The timing generator 15 outputs a pulse used to drive the pixel array 10.

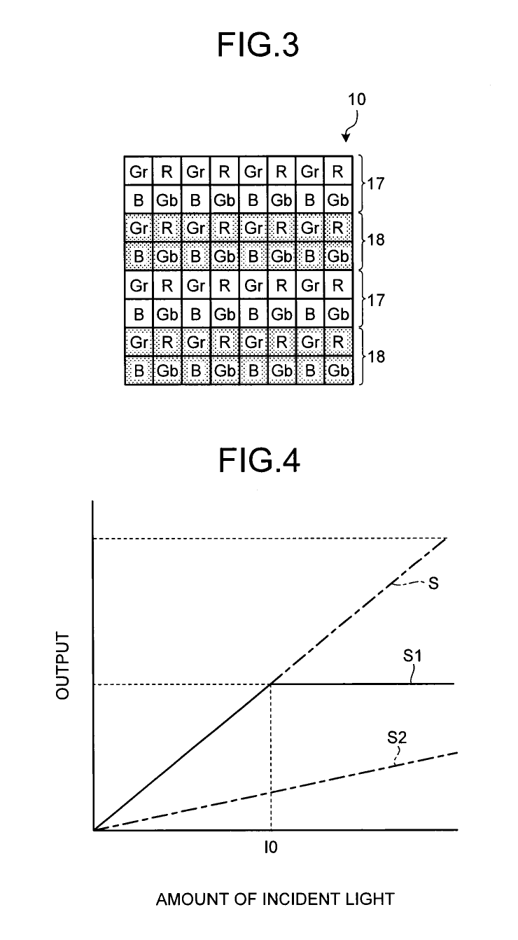

FIG. 3 is a diagram illustrating the array of pixels in a pixel array. The pixel array 10 is installed in as a Bayer array of four Gr, R, Gb, and B pixels. The R pixel detects red light. The B pixel detects blue light. The Gr and Gb pixels detect green light. The Gr pixel is parallel to the R pixel in a horizontal line. The Gb pixel is parallel to the B pixel in a horizontal line.

In the pixel array 10, charge accumulation periods are set to be alternately different for each line area including two horizontal lines of a Gr/R line and a B/Gb line. A first charge accumulation period which is a charge accumulation period of a long-time exposure line area (first line area) 17 is longer than a second charge accumulation period which is a charge accumulation period of a short-time exposure line area (second line area) 18.

The long-time exposure line area 17 includes two horizontal lines formed by long-time exposure pixels which are first pixels. The short-time exposure line area 18 includes two horizontal lines formed by short-time exposure pixels which are second pixels. The long-time exposure line area 17 and the short-time exposure line area 18 are alternately disposed in the vertical direction.

The long-time exposure pixel detects the amount of incident light during the first charge accumulation period. The short-time exposure pixel detects the amount of incident light during the second charge accumulation period. The pixel array 10 outputs a long-time exposure image signal (a first image signal) according to the amount of incident light on the long-time exposure pixels during the first charge accumulation period and a short-time exposure image signal (a second image signal) according to the amount of incident light on the short-time exposure pixels during the second charge accumulation period. The HDR synthesizing circuit 13 synthesizes the long-time exposure image signal and the short-time exposure image signal input to the imaging processing circuit 12.

FIG. 4 is a diagram illustrating output characteristics of the long-time exposure pixel and the short-time exposure pixel and synthesis of the image signals by the HDR synthesizing circuit. In the long-time exposure pixel, when the amount of incident light is higher than a predetermined saturated light amount I0, a signal charge generated through photoelectric conversion reaches an accumulation capacitance of a photodiode.

When the amount of incident light is equal to or less than the saturated light amount I0, the signal level of a long-time exposure image signal S1 increases in proportion to an increase in the amount of incident light. When the amount of incident light is greater than the saturated light amount I0, the signal level of the long-time exposure image signal S1 is constant. Even when the amount of incident light is greater than the saturated light amount I0, the signal level of the short-time exposure image signal S2 increases in proportion to an increase in the amount of incident light.

The HDR synthesizing unit 13 multiplies the short-time exposure image signal S2 by a predetermined HDR magnification to cause the output level of the long-time exposure pixel to coincide with the output level of the short-time exposure pixel. The HDR magnification corresponds to an exposure ratio which is a ratio of the first charge accumulation period of the long-time exposure pixel to the second charge accumulation period of the short-time exposure pixel. The HDR synthesizing unit 13 generates a synthesized image signal S through an interpolation process using the long-time exposure image signal S1 and the short-time exposure image signal S2 multiplied by the HDR magnification.

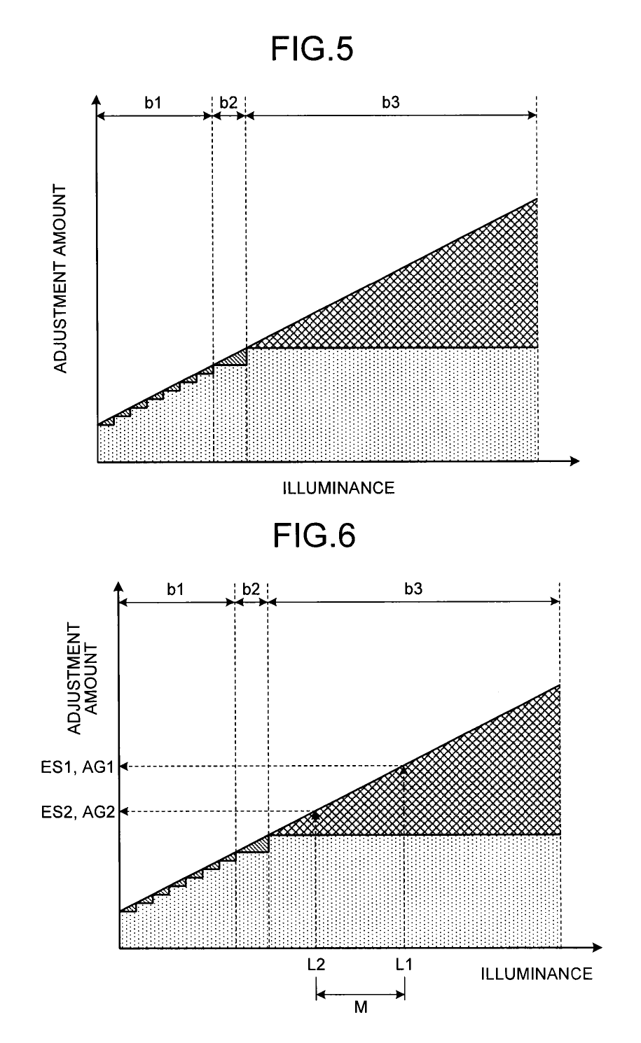

FIG. 5 is a diagram illustrating control of the AE operation performed by the AE control circuit. The vertical axis of an illustrated graph represents an adjustment amount of a signal level with respect to incident light. The AE control circuit 16 causes the adjustment amount of the signal level to be variable through adjustment of the amount of charge accumulated according to the ES and an amplification ratio of the signal level according to the AG and the DG.

The horizontal axis of the illustrated graph represents illuminance. The illuminance is assumed to be lowered from the left to the right of the horizontal axis direction. The AE control circuit 16 increases the adjustment amount of the signal level because a signal level increases as the illuminance is lowered at the time of shooting. In the drawing, a portion indicated by a tone represents an adjustment amount of the signal level according to the ES, a portion indicated by a diagonal line represents an adjustment amount of the signal level according to the DG, and a portion indicated by a hatching represents an adjustment amount of the signal level according to the AG.

In the camera module 2, so-called flicker in which lightness and darkness of an image is changed due to a power frequency of a fluorescent lamp supplying illumination light may occur at the time of indoor shooting. The camera module 2 can suppress the flicker by adjusting the ES using a double period of the period of the flicker as a unit. For example, when the power frequency of the fluorescent lamp is 60 Hz, the camera module 2 can suppress the flicker by adjusting the ES by 1/120 seconds.

For example, when a frame rate of a synthesized image is assumed to be 60 fps (frame per second), the camera module 2 sets the ES to one of 2/120 seconds and 1/120 seconds to suppress the flicker with 60 Hz. When the illuminance is high, the camera module 2 adjusts the ES within a range equal to or less than 1/120 seconds in order to prioritize the suppression of saturation of an output charge with respect to the amount of incident light than the suppression of the flicker.

In this example, the AE control circuit 16 divides an illuminance range with which shooting sensitivity is correlated by the camera module 2 into three stages and switches the control (lightness adjustment) of the AE operation according to the ES, the AG, and the DG. The AE control circuit 16 fixes the ES to 2/120 seconds within a low illuminance range b3 and adjusts only the AG. The AE control circuit 16 fixes the ES to 1/120 seconds within an illuminance range b2 which is a higher illuminance range than the illuminance range b3 and adjusts only the DG.

The AE control circuit 16 adjusts the ES to be shorter step by step with an increase in the illuminance within an illuminance range b1 which is a higher illuminance range than the illuminance range b2. The AE control circuit 16 adjusts a change amount of the illuminance corresponding to a unit less than a quantization unit of the ES according to the DG. Further, when the quantization unit of the ES is equal to or less than the resolution of the illuminance, the AE control circuit 16 may not perform the adjustment according to the DG.

The form of the control of the AE operation by the AE control circuit 16 can be appropriately changed. For example, after determining the ES according to the illuminance, the AE control circuit 16 may adjust one of the AG and the DG or may adjust both the AG and the DG.

The AE control circuit 16 may appropriately change the setting of the ES according to the frame rate of a synthesized image or the period of flicker. When the frame rate of a synthesized image is set to 30 fps with respect to the flicker with a frequency of 60 Hz, the AE control circuit 16 can adjust the ES to 4/120 seconds maximally. When the frequency of the flicker is 50 Hz, the AE control circuit 16 adjusts the ES by 1/100 seconds.

FIG. 6 is a diagram illustrating calculation of control amounts of the ES, the AG, and the DG by the AE control circuit. The AE control circuit 16 performs the control of the AE operation on one of the long-time exposure image signal and the short-time exposure image signal designated as a main control signal. The AE control circuit 16 causes the AE operation for a sub-control signal to follow the AE operation for the main control signal. The sub-control signal is one of the long-time exposure image signal and the short-time exposure image signal other than the main control signal.

For example, it is assumed that the long-time exposure image signal is designated as the main control signal. The AE control circuit 16 calculates proper exposure L1 for the long-time exposure pixel based on the long-time exposure image signal and calculates a control amount according to the proper exposure L1. For example, when the proper exposure L1 falls within the illuminance range b3, the AE control circuit 16 calculates a control amount ES1 (for example, 2/120 seconds) for the ES and a control amount AG1 (for example, six times) for the AG.

The AE control circuit 16 calculates proper exposure L2 for the short-time exposure pixel by multiplying the proper exposure L1 by an HDR magnification M. For example, when the HDR magnification M is set to four times, the AE control circuit 16 multiples the proper exposure L1 by 4 to calculate the proper exposure L2.

The AE control circuit 16 calculates a control amount according to the proper exposure L2. For example, when the proper exposure L2 falls within the illuminance range b3, the AE control circuit 16 calculates a control amount ES2 (for example, 2/120 seconds) for the ES and a control amount AG2 (for example, 1.5 times) for the AG.

In FIG. 6, a gap between L1 and L2 in the horizontal axis direction corresponds to a difference in the illuminance according to the HDR magnification M. The AE control of causing the AE operation of the sub-control signal to follow the AE operation of the main control signal can be expressed as an operation of referring to an adjustment amount of the vertical axis by moving L1 and L2 in the horizontal axis direction with the gap between L1 and L2 maintained in the horizontal axis direction in FIG. 6.

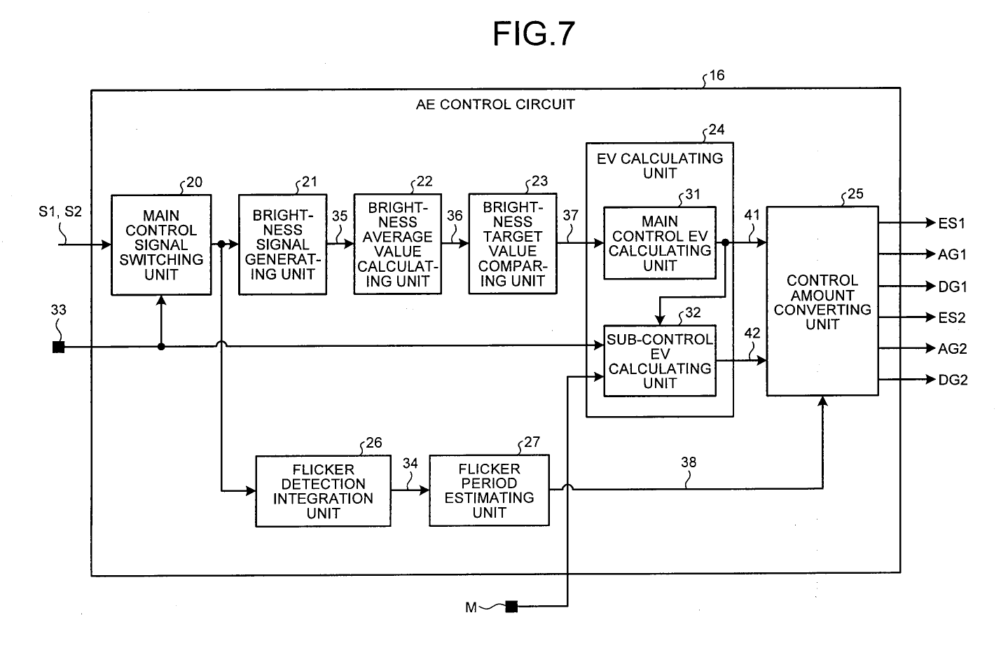

FIG. 7 is a block diagram illustrating the configuration of the AE control circuit. The AE control circuit 16 includes a main control signal switching unit 20, a brightness signal generating unit 21, a brightness average value calculating unit 22, a brightness target value comparing unit 23, an EV calculating unit 24, a control amount converting unit 25, a flicker detection integration unit 26, and a flicker period estimating unit 27.

The long-time exposure image signal S1 and the short-time exposure image signal S2 from the imaging processing circuit 12 (see FIG. 1) are input to the AE control circuit 16. The main control signal switching unit 20 outputs, as the main control signal, one of the long-time exposure image signal S1 and the short-time exposure image signal S2 input to the AE control circuit 16. The main control signal switching unit 20 switches the output as the main control signal between the long-time exposure image signal S1 and the short-time exposure image signal S2 according to a change instruction signal 33 used to give an instruction to change the main control signal.

For example, the change instruction signal 33 is set as a signal generated in response to a user's setting operation. For example, when the image quality of a dark portion of an image is considered to be important, the camera module 2 may select the long-time exposure image signal S1 from the long-time exposure pixel as the main control signal.

The brightness signal generating unit 21 generates a brightness signal 35 from the main control signal from the main control signal switching unit 20. The brightness signal 35 is, for example, a signal for information corresponding to a brightness component of a YUV color space. For example, the brightness signal generating unit 21 extracts brightness information on a G component from RAW image data which is the main control signal and sets the extracted brightness information as the brightness signal 35. The brightness signal generating unit 21 sets the brightness values of G components detected with a Gr pixel and a Gb pixel as the brightness signal 35.

The brightness signal generating unit 21 uses, as the brightness signal 35, the brightness value of a G component from which the most information on the brightness can be obtained among the R, G, and B components. The embodiment is not limited to the case in which the brightness signal generating unit 21 generates the brightness signal 35 only from the brightness value of the G component. For example, the brightness signal generating unit 21 may generate the brightness signal 35 using the brightness values of the R, G, and B components. The brightness signal 35 may be, for example, a signal obtained by adding the brightness values of the R, G, and B components by a predetermined ratio.

The brightness average value calculating unit 22 integrates and averages the brightness signals 35 of the entire screen and calculates a brightness average value 36. The brightness average value calculating unit 22 may calculate the brightness average value 36 after weighting the brightness signals 35 for each area set in a screen.

The brightness target value comparing unit 23 compares the brightness average value 36 from the brightness average value calculating unit 22 to a preset brightness target value and calculates a difference. The brightness target value comparing unit 23 outputs a difference between the brightness average value 36 and the brightness target value as a lightness adjustment amount 37 used to adjust the lightness of a synthesized image according to illuminance at the time of shooting. For example, an adjustment amount of an exposure value (EV) for exposure correction is set as the lightness adjustment amount 37.

The EV calculating unit 24 includes a main control EV calculating unit 31 and a sub-control EV calculating unit 32. The main control EV calculating unit 31 calculates a main control EV 41. The main control EV 41 is an EV for the main control signal. The main control EV calculating unit 31 calculates the main control EV 41 by performing calculation to reflect the lightness adjustment amount 37 from the brightness target value comparing unit 23 to the lightness of an image by the main control signal. The main control EV 41 corresponds to the proper exposure L1 for the main control signal.

The sub-control EV calculating unit 32 calculates a sub-control EV 42. The sub-control EV 42 is an EV for the sub-control signal. The sub-control EV calculating unit 32 multiplies the main control EV 41 calculated by the main control EV calculating unit 31 by the HDR magnification M and sets the multiplication result as the sub-control EV 42. The sub-control EV 42 corresponds to the proper exposure L2 for the sub-control signal.

The sub-control EV calculating unit 32 determines whether one of the long-time exposure image signal S1 and the short-time exposure image signal S2 is the sub-control signal based on the change instruction signal 33. For example, when the HDR magnification M is set to four times and the long-time exposure image signal S1 is designated as the main control signal, the sub-control EV calculating unit 32 multiplies the main control EV 41 by ¼ and sets the multiplication result as the sub-control EV 42. On the other hand, when the HDR magnification M is set to four times and the short-time exposure image signal S2 is designated as the main control signal, the sub-control EV calculating unit 32 multiplies the main control EV 41 by four and sets the multiplication result as the sub-control EV 42. Further, the HDR magnification M is set to, for example, a fixed value set in advance.

The flicker detection integration unit 26 performs integration for the flicker detection on the main control signal from the main control signal switching unit 20 and outputs an integration result 34. The flicker period estimating unit 27 estimates the period of the flicker based on the integration result 34 from the flicker detection integration unit 26, and outputs an estimation result 38.

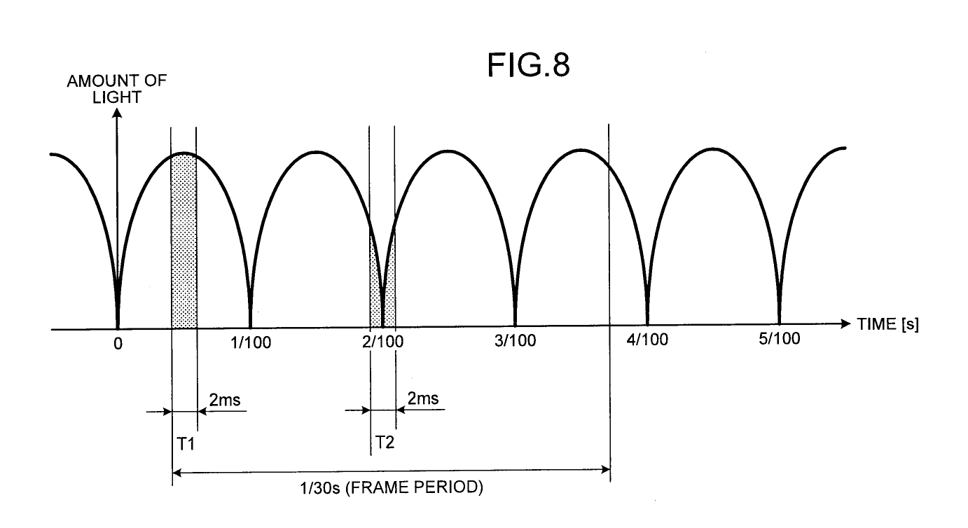

FIG. 8 is a diagram illustrating occurrence of flicker. The illumination of a fluorescent lamp blinks at the frequency which is the double of the power frequency. By sequentially reading signal charges of each line, exposure start times by an electronic shutter are different depending on the positions of the read lines. Thus, in a frame, uneven brightness caused due to the blinking of the fluorescent lamp is shown as bright and dark stripes.

The flicker period is 1/100 s or 1/120 s with respect to the power frequency of 50 Hz or 60 Hz. For example, when the frame period is 1/30 s with respect to the power frequency of 50 Hz, stripes with of a period of 1/100 s occur in which a line corresponding to a horizontal synchronization period T1 in which the amount of light is the maximum is a bright portion and a line corresponding to a horizontal synchronization period T2 in which the amount of light is the minimum is a dark portion. The horizontal synchronization periods T1 and T2 are set to, for example, two ms.

The flicker detection integration unit 26 performs integration of the main control signal for which a line is used as a unit in several portions in the screen. The flicker period estimating unit 27 estimates the flicker period from a difference between the integration results 34 of respective portions in the screen. For example, the flicker period estimating unit 27 estimates one of the flicker period of 1/100 s and the flicker period of 1/120 s by comparing the difference between the integration results 34 at the intervals of 1/100 s to the difference between the integration results 34 at the intervals of 1/120 s.

When the frame period is an integer multiple of 1/100 s with respect to the power frequency of 50 Hz and the frame period is an integer multiple of 1/120 s with respect to the power frequency of 60 Hz, the amount of exposure becomes constant irrespective of an exposure timing, and thus no flicker occurs. The flicker period estimating unit 27 estimates the period of flicker occurring when the frame period is not an integer multiple of the period of the blinking of the fluorescent lamp.

The control amount converting unit 25 converts the main control EV 41 from the main control EV calculating unit 31 into the control amount ES1 for the ES, the control amount AG1 for the AG, and a control amount DG1 for the DG. The control amount converting unit 25 determines the control amount ES1 according to the main control EV 41 as the proper exposure L1 which falls within a given illuminance range (for example, b1 to b3 illustrated in FIG. 6).

In the example illustrated in FIG. 6, when the main control EV 41 falls within one of the illuminance ranges b2 and b3, the control amount converting unit 25 determines the control amount ES1 according to the flicker period output as an estimation result 38. The control amount converting unit 25 sets a value of an integer multiple of the estimated flicker period as the control amount ES1.

When the main control EV 41 falls within the illuminance range b3, the control amount converting unit 25 determines the control amount AG1 according to the main control EV 41 based on a linear relation between the main control EV 41 and the control amount AG1. When the main control EV 41 falls within the illuminance range b2, the control amount converting unit 25 determines the control amount DG1 according to the main control EV 41 based on a linear relation between the main control EV 41 and the control amount DG1.

When the main control EV 41 falls within the illuminance range b1, the control amount converting unit 25 determines the control amount ES1 corresponding to the main control EV 41 from the ES set step by step according to the illuminance. In this case, the control amount converting unit 25 determines the control amount ES1 irrespective of the flicker period which is the estimation result 38. The control amount converting unit 25 determines the control amount DG1 according to the main control EV 41 based on a linear relation between the main control EV 41 and the control amount DG1 in the quantization unit of the ES.

The control amount converting unit 25 converts the sub-control EV 42 from the sub-control EV calculating unit 32 into the control amount ES2 for the ES, the control amount AG2 for the AG, and a control amount DG2 for the DG. The control amount converting unit 25 determines the control amount ES2 according to the sub-control EV 42 as the proper exposure L2 which falls within a given illuminance range (for example, b1 to b3 illustrated in FIG. 6). As in the conversion of the main control EV 41 into the control amounts ES1, AG1, and DG1, the control amount converting unit 25 converts the sub-control EV 42 into the control amounts ES2, AG2, and DG2.

The control amount converting unit 25 performs the conversion of the main control EV 41 calculated by the main control EV calculating unit 31 into each control amount and the conversion of the sub-control EV 42 calculated by the sub-control EV calculating unit 32 into each control amount in a time division manner. The AE control circuit 16 uses the control amount converting unit 25 common to the generation of each control amount in regard to the main control signal and the sub-control signal, and thus the circuit size can be reduced.

For example, when the long-time exposure image signal S1 is designated as the main control signal, the timing generator 15 illustrated in FIG. 1 outputs a pulse suitable for the control amount ES1 to the long-time exposure pixel in the pixel array 10. The timing generator 15 outputs a pulse suitable for the control amount ES2 to the short-time exposure pixel in the pixel array 10.

Further, when the long-time exposure image signal S1 is designated as the main control signal, the preprocessing unit 11 illustrated in FIG. 1 amplifies the long-time exposure image signal S1 using the control amounts AG1 and DG1. The preprocessing unit 11 amplifies the short-time exposure image signal S2 using the control amounts AG2 and DG2.

The EV calculating unit 24 calculates the main control EV 41 and the sub-control EV 42 falling within the illuminance range in which the camera module 2 has shooting sensitivity. The main control EV calculating unit 31 sets a limitation on the main control EV 41 so that not only the main control EV 41 but also the sub-control EV 42 calculated by the sub-control EV calculating unit 32 are included in the illuminance range.

For example, when the long-time exposure image signal S1 is designated as the main control signal, the sub-control EV 42 for the short-time exposure image signal S2 have a value which is larger than the main control EV 41 by the HDR magnification M. The main control EV calculating unit 31 limits the maximum value of the main control EV 41 so that the sub-control EV 42 is included in a range equal to or less than the maximum illuminance in which the camera module 2 has shooting sensitivity. Referring to the graph of FIG. 6, adjustment of L1 is limited such that L1 can be moved to the left side (high illuminance side) of the graph within the limit of the left end of the graph reached by L2 located to the left side from L1 by M.

For example, when the short-time exposure image signal S2 is designated as the main control signal, the sub-control EV 42 for the long-time exposure image signal S1 have a value which is smaller than the main control EV 41 by the HDR magnification M. The main control EV calculating unit 31 limits the minimum value of the main control EV 41 so that the sub-control EV 42 is included in a range equal to or greater than the minimum illuminance in which the camera module 2 has shooting sensitivity. Referring to the graph of FIG. 6, adjustment of L2 is limited such that L2 can be moved to the right side (low illuminance side) of the graph within the limit of the right end of the graph reached by L1 located to the right side from L2 by the HDR magnification M.

The EV calculating unit 24 can acquire the main control EV 41 and the sub-control EV 42 according to the shooting sensitivity of the camera module 2 by providing such limitations on the main control EV 41. The AE control circuit 16 can perform the control of the AE operation according to the shooting sensitivity of the camera module 2 on both the long-time exposure image signal S1 and the short-time exposure image signal S2.

For example, the camera module 2 is assumed to switch between an HDR shooting mode in which the HDR synthesis is performed and a normal shooting mode in which the HDR synthesis is not performed. In the HDR shooting mode, the AE control circuit 16 calculates each control amount for the long-time exposure image signal S1 and the short-time exposure image signal S2.

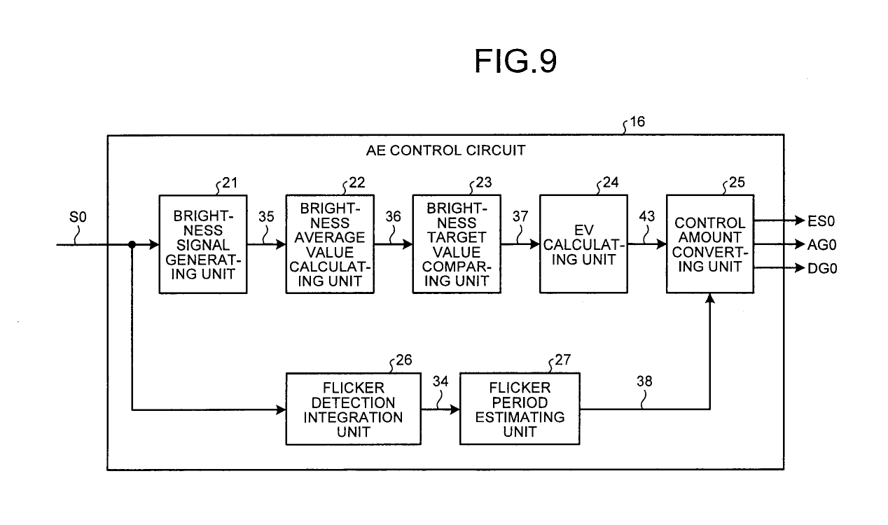

FIG. 9 is a block diagram illustrating elements used for the control of the AE operation in the normal shooting mode in the AE control circuit illustrated in FIG. 7. In the normal shooting mode, the solid-state imaging device 5 applies the same charge accumulation period to the respective pixels classified into the long-time exposure pixel and the short-time exposure pixel in the HDR shooting mode.

An image signal SO from the imaging processing circuit 12 is input to the AE control circuit 16. The brightness signal generating unit 21 generates the brightness signal 35 from the image signal S0. The brightness average value calculating unit 22 integrates and averages the brightness signals 35 and calculates the brightness average value 36. The brightness target value comparing unit 23 outputs a difference between the brightness average value 36 and the brightness target value as a lightness adjustment amount 37 used to adjust the lightness of an image according to illuminance at the time of shooting. The EV calculating unit 24 calculates the EV 43 by performing calculation to reflect the lightness adjustment amount 37 from the brightness target value comparing unit 23 to the lightness of an image by the image signal S0.

The flicker detection integration unit 26 performs integration for the flicker detection on the image signal S0 and outputs an integration result 34. The flicker period estimating unit 27 estimates the period of the flicker based on the integration result 34 from the flicker detection integration unit 26, and outputs an estimation result 38. The control amount converting unit 25 converts the EV 43 from the EV calculating unit 24 into a control amount ES0 for the ES, a control amount AG0 for the AG, and a control amount DG0 for the DG. In the normal shooting mode, the control amount converting unit 25 calculates each control amount for the image signal S0 obtained by applying the same charge accumulation period on each pixel.

The timing generator 15 illustrated in FIG. 1 outputs a pulse suitable for the control amount ES0 to the pixel array 10. The preprocessing unit 11 amplifies the image signal S0 based on the control amounts AG0 and DG0.

The solid-state imaging device 5 according to the first embodiment performs the AE control through a simple calculation process, compared to a case in which a continuously adjusted HDR magnification M is applied, by calculating the control amounts for the sub-control signal based on the fixed HDR magnification M. The solid-state imaging device 5 can control the AE operation according to the lightness at the time of shooting through the simple calculation process in relation to the long-time exposure image signal and the short-time exposure image signal.

The AE control circuit 16 can reduce the circuit size and shorten the processing time by simplifying the calculation process. The solid-state imaging device 5 can realize the control of the AE operation in the HDR shooting mode by adding a circuit with a relatively small size such as the sub-control EV calculating unit 32 to the circuit configuration in which the HDR synthesis is not performed. The solid-state imaging device 5 can be configured by a small and simple circuit.

Each circuit configuration described in this embodiment may realize the function described in this embodiment and may be appropriately modified.

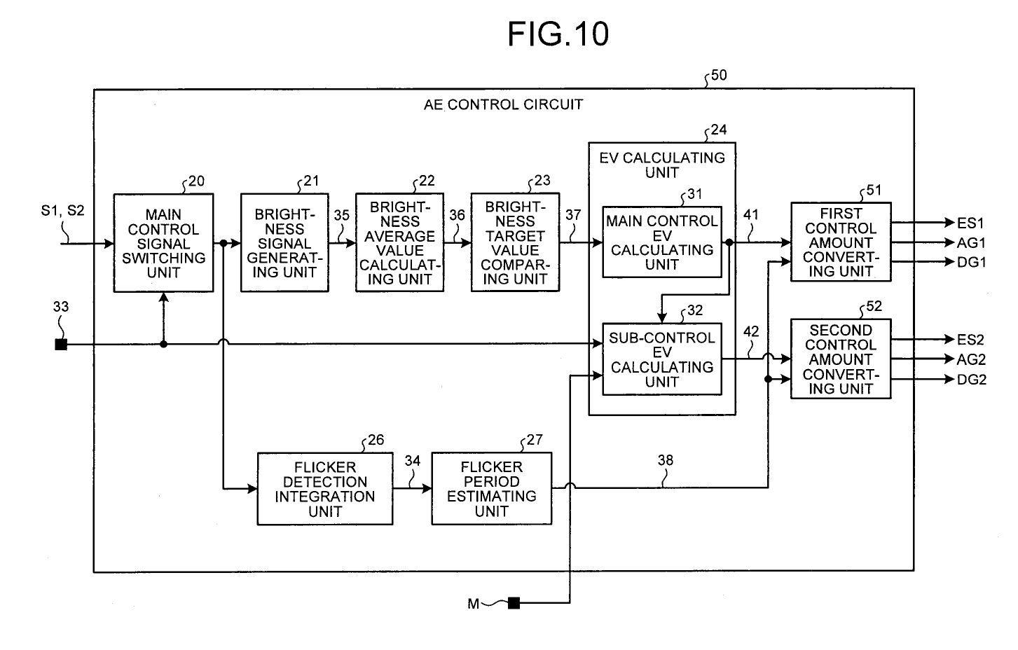

FIG. 10 is a block diagram illustrating the configuration of an AE control circuit included in an image processing device according to a second embodiment. An AE control circuit 50 according to this embodiment can be applied to the solid-state imaging device 5 (see FIG. 1) according to the first embodiment. The same reference numerals are given to the same units as those of the first embodiment and the description thereof will not be repeated.

The AE control circuit 50 includes a first control amount converting unit (control amount converting unit for main control) 51 and a second control amount converting unit (control amount converting unit for sub-control) 52 which are control amount converting units, instead of the control amount converting unit 25 illustrated in FIG. 7.

The first control amount converting unit 51 converts a main control EV 41 calculated by a main control EV calculating unit 31 into control amounts ES1, AG1, and DG1. The second control amount converting unit 52 converts a sub-control EV 42 calculated by a sub-control EV calculating unit 32 into control amounts ES2, AG2, and DG2.

The solid-state imaging device 5 according to the second embodiment can be configured by a small and simple circuit, as in the first embodiment. The AE control circuit 50 performs conversion of the main control EV 41 into each control amount by the first control amount converting unit 51 and conversion of the sub-control EV 42 into each control amount by the second control amount converting unit 52 in parallel. The AE control circuit 50 causes the AE operation to be performed faster by acquiring the control amounts in regard to the main control signal and the sub-control signal in parallel.

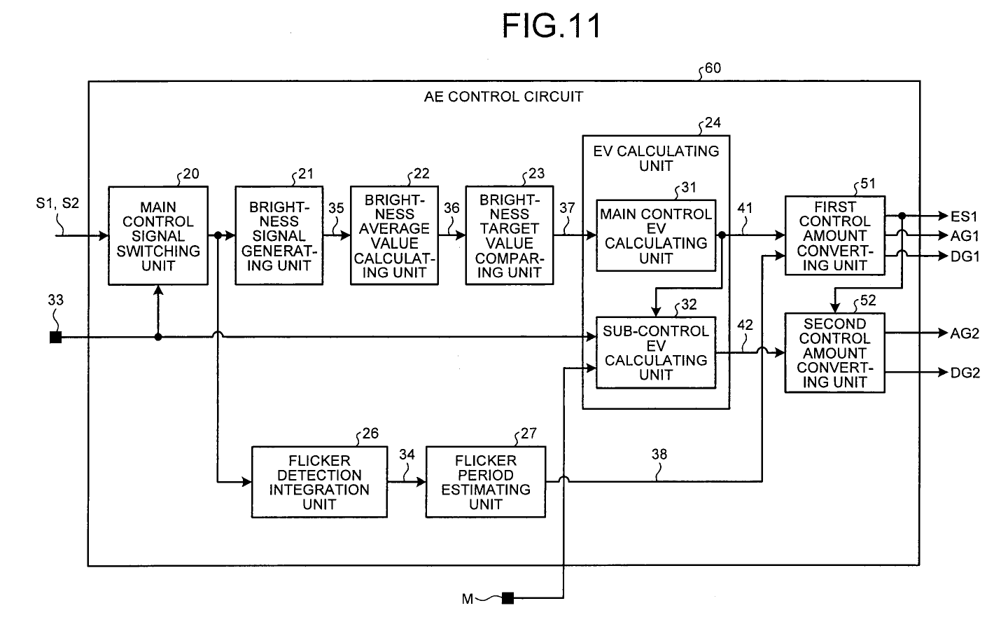

FIG. 11 is a block diagram illustrating the configuration of an AE control circuit included in an image processing device according to a third embodiment. The AE control circuit 60 according to this embodiment can be applied to the solid-state imaging device 5 (see FIG. 1) according to the first embodiment. The same reference numerals are given to the same units as those of the first and second embodiments and the description thereof will not be repeated.

The first control amount converting unit 51 outputs the control amount ES1 calculated from a main control EV 41 to the second control amount converting unit 52. The first control amount converting unit 51 and the second control amount converting unit 52 which are control amount converting units applies the same control amount ES1 for the ES to the main control signal and the sub-control signal. The second control amount converting unit 52 determines the control amounts AG2 and DG2 according to the control amount ES1 from the first control amount converting unit 51 and the sub-control EV 42 from the sub-control EV calculating unit 32. The first control amount converting unit 51 and the second control amount converting unit 52 set different control amounts for at least one of the AG and the DG in regard to the main control signal and the sub-control signal.

The timing generator 15 illustrated in FIG. 1 outputs a pulse suitable for the control amount ES1 to both the long-time exposure pixel and the short-time exposure pixel of the pixel array 10. The AE control circuit 60 performs conversion of the main control EV 41 into each control amount by the first control amount converting unit 51 and conversion of the sub-control EV 42 into each control amount by the second control amount converting unit 52 in parallel. The AE control circuit 60 causes the AE operation to be performed faster by acquiring the control amounts in regard to the main control signal and the sub-control signal in parallel.

The AE control circuit 60 may include a control amount converting unit 25 (see FIG. 7) of the first embodiment instead of the first control amount converting unit 51 and the second control amount converting unit 52. In this case, the control amount converting unit 25 performs conversion of the main control EV 41 calculated by the main control EV calculating unit 31 into each control amount and conversion of the sub-control EV 42 calculated by the sub-control EV calculating unit 32 into each control amount in a time division manner. The AE control circuit 60 uses the control amount converting unit 25 common to the generation of each control amount in regard to the main control signal and the sub-control signal, and thus the circuit size can be reduced.

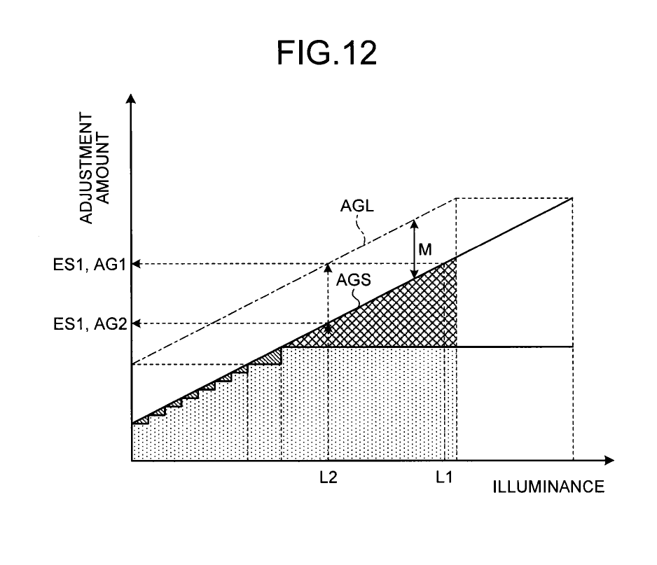

FIG. 12 is a diagram illustrating calculation of control amounts of ES, AG, and DG by the AE control circuit. The AE control circuit 60 performs the control of the AE operation on one of the long-time exposure image signal S1 and the short-time exposure image signal S2 designated as a main control signal. The AE control circuit 60 causes the AE operation on the sub-control signal which is one of the ling-time exposure image signal S1 and the short-time exposure image signal S2 other than the main control signal to follow the AE operation in regard to the main control signal.

For example, it is assumed that the long-time exposure image signal S1 is designated as the main control signal. The first control amount converting unit 51 calculates proper exposure L1 for the long-time exposure pixel based on the long-time exposure image signal S1. The first control amount converting unit 51 calculates the control amounts such as the ES1 and the AG1 according to the proper exposure L1.

The AE control circuit 60 calculates proper exposure L2 for the short-time exposure pixel by multiplying the proper exposure L1 by an HDR magnification M. The second control amount converting unit 52 calculates a control amount according to the proper exposure L2. The second control amount converting unit 52 uses the control amount ES1 for the long-time exposure image signal S1 as the control amount for the ES without change. Further, the second control amount converting unit 52 calculates the control amount such as the AG2 other than the ES according to the property exposure L2.

In FIG. 12, a straight line AGL represents a relation between the control amount for the AG in regard to the long-time exposure image signal S1 and the illuminance. A straight line AGS represents a relation between the control amount for the AG in regard to the short-time exposure image signal S2 and the illuminance. The gap between the straight line AGL and the straight line AGS in the vertical axis direction corresponds to the difference in the AG according to the HDR magnification M.

For example, when the proper exposure L2 falls within the illuminance range b1, the proper exposure L1 falls within the illuminance range b2 or b3 (see FIG. 6 in regard to the illuminance ranges b1, b2, and b3), and the illuminance width of the proper exposures L1 and L2 cover the plurality of illuminance ranges, the AE operation is different between the long-time exposure pixel and the short-time exposure pixel. When different control amounts for the ES are applied to the long-time exposure pixel and the short-time exposure pixel, flicker may occur only in the short-time exposure pixel for which the proper exposure L2 is a high illuminance side. The flicker in the short-time exposure pixel occurs more easily, as an illuminance width between the proper exposure L1 and the proper exposure L2 is larger, that is, as the HDR magnification M is larger.

The AE control circuit 60 according to the third embodiment can prevent the flicker from occurring in the short-time exposure pixel by applying the same control amount for the ES to the long-time exposure pixel and the short-time exposure pixel. The AE control circuit 60 according to this embodiment is appropriate when the prevention of the flicker is desirable.

For example, when the camera module 2 mounted on a drive recorder takes a picture of a traffic light in which an LED is used for display, the LED is not turned on and an image is recorded from a deviation between a frame rate and a period in which the LED is turned on and off. In this case, when the camera module 2 prevents the flicker from occurring by applying the AE control circuit 60 according to this embodiment, signal display of the LED can be accurately recorded.

The solid-state imaging device 5 according to the third embodiment can be configured by a small and simple circuit, as in the first embodiment. Further, when the AE control circuit 60 applies the control amount ES1 determined in regard to the main control signal to the sub-control signal without change, a process of separately calculating the control amount for the ES in regard to the sub-control signal may not be provided. Thus, the solid-state imaging device 5 can cause the AE operation to be performed faster.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing device comprising:
a high dynamic range synthesizing unit that generates a synthesized image by synthesizing a first image signal in accordance with an amount of light incident on a first pixel during a first charge accumulation period and a second image signal in accordance with an amount of light incident on a second pixel during a second charge accumulation period shorter than the first charge accumulation period;
an exposure value calculating unit that calculates an exposure value to which a lightness adjustment amount used to adjust lightness of the synthesized image in accordance with illuminance at the time of shooting; and
a control amount converting unit that converts the exposure value into respective control amounts for an electronic shutter time, an analog gain, and a digital gain,
wherein the exposure value calculating unit includes
a main control exposure value calculating unit that calculates a main control exposure value which is the exposure value for the main control signal based on a signal designated as a main control signal between the first image signal and the second image signal, and
a sub-control exposure value calculating unit that calculates a sub-control exposure value which is the exposure value for a sub-control signal, which is one of the first image signal and the second image signal other than the main control signal and causes the main control signal to follow lightness adjustment, and
wherein the sub-control exposure value calculating unit multiplies the main control exposure value calculated by the main control exposure value calculating unit by a high dynamic range magnification set in advance as a ratio of the first charge accumulation period to the second charge accumulation period, and sets the multiplication result as the sub-control exposure value.

2. The image processing device according to claim 1, wherein the control amount converting unit performs conversion of the main control exposure value calculated by the main control exposure value calculating unit into the respective control amounts and conversion of the sub-control exposure value calculated by the sub-control exposure value calculating unit into the respective control amounts in a time division manner.

3. The image processing device according to claim 1,
wherein the control amount converting unit includes a control amount converting unit for main control and a control amount converting unit for sub-control,
the control amount converting unit for main control converts the main control exposure value calculated by the main control exposure value calculating unit into the respective control amounts, and
the control amount converting unit for sub-control converts the sub-control exposure value calculated by the sub-control exposure value calculating unit into the respective control amounts.

4. The image processing device according to claim 1, wherein the control amount converting unit sets the same control amount in the electronic shutter time for the main control signal and the sub-control signal and sets different control amounts for at least the analog gain in regard to the main control signal and the sub-control signal.

5. The image processing device according to claim 1, wherein the high dynamic range magnification is fixed.

6. The image processing device according to claim 1, wherein the main control exposure value calculating unit sets limitation on the main control exposure value so that the sub-control exposure value calculated by the sub-control exposure value calculating unit falls within an illuminance range according to shooting sensitivity.

7. The image processing device according to claim 1, further comprising:
a flicker period estimating unit that estimates a flicker period from an integration result of the main control signal,
wherein the control amount converting unit determines the control amount for the electronic shutter time in accordance with an estimation result of the flicker period estimating unit.

8. The image processing device according to claim 1,
wherein, in a high dynamic range shooting mode in which high dynamic range synthesis is performed, the control amount converting unit calculates the respective control amounts for the first image signal and the second image signal, and
in a normal shooting mode in which the high dynamic range synthesis is not performed, the control amount converting unit calculates the respective control amounts for an image signal obtained by applying the same charge accumulation time to each pixel.

9. An image processing method comprising:
generating a synthesized image by synthesizing a first image signal in accordance with an amount of light incident on a first pixel during a first charge accumulation period and a second image signal in accordance with an amount of light incident on a second pixel during a second charge accumulation period shorter than the first charge accumulation period;
calculating an exposure value to which a lightness adjustment amount used to adjust lightness of the synthesized image in accordance with illuminance at the time of shooting;
converting the exposure value into respective control amounts for an electronic shutter time, an analog gain, and a digital gain;
designating one of the first image signal and the second image signal as a main control signal; and
designating one of the first image signal and the second image signal other than the main control signal as a sub-control signal causing the main control signal to follow lightness adjustment,
wherein the calculating of the exposure value includes calculating a main control exposure value which is the exposure value for the main control signal and calculating a sub-control exposure value which is the exposure value for the sub-control signal, and
a result obtained by multiplying a high dynamic range magnification set in advance as a ratio of the first charge accumulation period to the second charge accumulation period by the main control exposure value is set as the sub-control exposure value.

10. The image processing method according to claim 9, wherein conversion of the main control exposure value into the respective control amounts and conversion of the sub-control exposure value into the respective control amounts are performed in a time division manner.

11. The image processing method according to claim 9, wherein conversion of the main control exposure value into the respective control amounts and conversion of the sub-control exposure value into the respective control amounts are performed in parallel.

12. The image processing method according to claim 9, wherein the same control amount is set in the electronic shutter time for the main control signal and the sub-control signal and different control amounts are set at least in the analog gain for the main control signal and the sub-control signal.

13. The image processing method according to claim 9, wherein the high dynamic range magnification is fixed.

14. The image processing method according to claim 9, wherein limitation on the main control exposure value is set so that the sub-control exposure value falls within an illuminance range according to shooting sensitivity.

15. The image processing method according to claim 9, further comprising:
estimating a flicker period from an integration result of the main control signal,
wherein the control amount for the electronic shutter time is determined in accordance with an estimation result of the flicker period.

16. The image processing method according to claim 9,
wherein, in a high dynamic range shooting mode in which high dynamic range synthesis is performed, the respective control amounts for the first image signal and the second image signal are calculated, and
in a normal shooting mode in which the high dynamic range synthesis is not performed, the respective control amounts for an image signal obtained by applying the same charge accumulation time to each pixel are calculated.

17. A solid-state imaging device comprising:
a pixel array that includes a first pixel detecting an amount of incident light during a first charge accumulation period and a second pixel detecting an amount of incident light during a second charge accumulation period shorter than the first charge accumulation period;
a high dynamic range synthesizing unit that generates a synthesized image by synthesizing a first image signal output in accordance with the amount of incident light by the first pixel and a second image signal output in accordance with the amount of incident light by the second pixel;
an exposure value calculating unit that calculates an exposure value to which a lightness adjustment amount used to adjust lightness of the synthesized image in accordance with illuminance at the time of shooting; and
a control amount converting unit that converts the exposure value into respective control amounts for an electronic shutter time, an analog gain, and a digital gain,
wherein the exposure value calculating unit includes
a main control exposure value calculating unit that calculates a main control exposure value which is the exposure value for the main control signal based on a signal designated as a main control signal between the first image signal and the second image signal, and
a sub-control exposure value calculating unit that calculates a sub-control exposure value which is the exposure value for a sub-control signal, which is one of the first image signal and the second image signal other than the main control signal and causes the main control signal to follow lightness adjustment, and
wherein the sub-control exposure value calculating unit multiplies the main control exposure value calculated by the main control exposure value calculating unit by a high dynamic range magnification set in advance as a ratio of the first charge accumulation period to the second charge accumulation period, and sets the multiplication result as the sub-control exposure value.

18. The solid-state imaging device according to claim 17,
wherein the solid-state imaging device is able to switch a high dynamic range shooting mode in which high dynamic range synthesis is performed and a normal shooting mode in which the high dynamic range synthesis is not performed, and
the control amount converting unit calculates the respective control amounts for the first image signal and the second image signal in the high dynamic range shooting mode and calculates the respective control amounts for an image signal obtained by applying the same charge accumulation time to each pixel in the normal shooting mode.

19. The solid-state imaging device according to claim 17, wherein the control amount converting unit performs conversion of the main control exposure value calculated by the main control exposure value calculating unit into the respective control amounts and conversion of the sub-control exposure value calculated by the sub-control exposure value calculating unit into the respective control amounts in a time division manner.

20. The solid-state imaging device according to claim 17, wherein the control amount converting unit sets the same control amount in the electronic shutter time for the main control signal and the sub-control signal and sets different control amounts at least in the analog gain for the main control signal and the sub-control signal.
